(19) United States
(12) Patent Application Publication
(10) Pub. No.: US 2014/0011934 A1
(43) Pub. Date: Jan. 9, 2014

(54) USE OF NEW ADDITIVES IN A PAINT FORMULATION INCLUDING PARTICLES OF TITANIUM DIOXIDE AS AGENTS FOR IMPROVING THE OPACITY OF THE DRY FILM OR FILM THAT IS IN THE PROCESS OF DRYING

(71) Applicant: COATEX S.A.S., Genay (FR)

(72) Inventors: Mehdi BOUZID, Fort Mill, SC (US); Jean-Marc Suau, Lucenay (FR); Denis Ruhlmann, Genay (FR); Olivier Guerret, Pern (FR)

(21) Appl. No.: 13/920,282

(22) Filed: Jun. 18, 2013

Related U.S. Application Data
(60) Provisional application No. 61/670,641, filed on Jul. 12, 2012.

(30) Foreign Application Priority Data
Jul. 6, 2012 (FR) 12 56547

(51) Int. Cl. C09D 133/02; C09D 133/14; C08K 3/34; C09D 133/04; C08K 3/22; C08K 3/26

(52) U.S. Cl. CPC C09D 133/02; C08K 3/22; C08K 3/26; C08K 3/346; C09D 133/04; C09D 133/14
USPC 524/425; 524/558; 524/555; 524/447

(57) ABSTRACT

The present invention concerns the use of new additives in a paint formulation containing particles of titanium dioxide (TiO₂) as an agent for improving the opacity of the film that is dry or in the process of drying as well as paint formulations including such agents.

### REFERENCE TO PRIOR APPLICATIONS

This application claims priority to U.S. provisional application Ser. No. 61/670,641, filed Jul. 12, 2012; and to French patent application 12/56,547, filed Jul. 6, 2012, both incorporated herein by reference.

The present invention relates to the use of new additives as agents for increasing the opacity of the film that is dry or in the process of drying of a paint formulation including titanium dioxide particles which enables a reduction in the amount of this pigment in paints.

Mineral pigments such as TiO₂ are products whose availability is becoming increasingly limited. This leads to an increase in their price. It is therefore sought to reduce their use in products containing them, including paints, without reducing the optical qualities of the paints.

Several strategies are designed to promote the beneficial aspects of titanium dioxide while minimizing the quantities needed. However, despite the use of dispersants in the formulations, the phenomenon of particle flocculation, particularly during drying of the paint film, reduces the opacifying effectiveness of the TiO₂. With this in mind, several techniques are available in the prior art for improving the spacing and distribution of TiO₂ pigment particles in paint.

In particular, some of these strategies lie in the substitution of part of the TiO₂ particles by another pigment, particularly in paints referred to as high pigment volume concentration paints. This additional pigment is then presented as a spacer/extender particle, that is, as a particle that mechanically spaces the TiO₂ pigment particles. However, such approaches are nevertheless unsatisfactory in that they lead, during the paint drying phase, to an agglomeration of the titanium dioxide particles, thus not having the anticipated effect on the optical qualities expected.

To resolve this technical problem, document WO 2006/023065 proposes the use of a special pigment of the metal oxide type such as zinc oxide, which is presented as having an affinity for the surface of TiO₂ particles. Also, there is mention in this document of the use of an oligomeric/polymeric dispersant intended to prevent flocculation in the dry film.

As for application US 2004/0202601, it describes a method for spacing TiO₂ particles by using spacer particles consisting of an additional pigment, notably of the calcium carbonate, silica, alumina type, and of a compound of the acrylic acid homopolymer/copolymer type. This polymeric compound is presented as having a role in the viscosity and dispersibility of the additional pigment in the composition.

These solutions are unsatisfactory in that they consist of a replacement of part of the titanium dioxide by another pigment, which often leads to making a compromise in the expected qualities of the finished products.

As regards documents EP 1 270 687 and EP 1 070 739, they describe the use of polymer particles adsorbed on the surface of pigment particles. The polymers referred to in these documents present a non-water-soluble structure, for example, of the styrene type, on which are grafted the pendant acid functional groups of the dihydrogen phosphate, phosphonate, sulfonic acid or multiacid type.

Thus, this strategy consists of encapsulating the particles of TiO₂ in a special latex. The technology resides in the mixture of a suspension of TiO₂ and latex in such a way as to coat the TiO₂ particles with this latex. The resulting particles are then used as a source of titanium dioxide in paint formulations. According to this approach, the choice of latex depends on the nature of the TiO₂ as well as the nature of the binder used in the paint. Thus, the technology described must be adapted to each paint formulation, which constitutes a major limitation in the use of such a technology.

An object of the present invention is to reduce the amount of TiO₂ particles used in paint formulations without reducing the expected optical qualities of the paint in the process.

Another object of the present invention is to reduce the amount of TiO₂ particles without necessarily having to compensate for this decrease by the addition of another pigment to the composition.

Another object of the present invention is to allow a reduction in the amount of TiO₂ in paints without a profound change in paint formulations, for example, without modifying the rheological properties.

Another object of the present invention is to reduce the amount of TiO₂ in paint formulations by an approach that is easily implemented by the formulator.

Another object of the present invention is to maintain separation and prevent flocculation between TiO₂ particles during drying of the paint film.

Another object of the present invention is to reduce the amount of TiO₂ in paints by using a low-dose compound while maintaining the expected optical properties.

The inventors realized surprisingly that by using a family of water-soluble polymers, all of these objectives were realised. The use of such polymers in fact allows an increase in the effectiveness of titanium dioxide and thus reduces its use without decreasing the performance of the paint and without substantially modifying the rheological properties of the formulations. In particular, the interest in these molecules is to produce this effect based on doses in the order of a few percent.

The present invention thus concerns the use in a paint formulation including titanium dioxide particles as an agent for improving the opacity of the film that is dry or in the process of drying, of a water-soluble comb type copolymer with a (meth)acrylic acid skeleton and polyalkylene glycol branches.

By “titanium dioxide” or “titanium dioxide particles” is meant particles of the rutile or anatase type, such as obtained by conventional industrial processes starting from ore, for example, by a sulphate process or a chloride process. According to the invention, the TiO₂ particles are in the form of suspensions, dispersions in a liquid, or in the powder form. When the TiO₂ is in the powder form, the particles have a particle size distribution characterized by a mean particle size between 100 and 500 nm, for example, between 200 and 400 nm, for example, a mean size of 250 nm. Such particles are available commercially.

By “polyalkylene glycol” is meant a polymer of an alkylene glycol derived from an olefin oxide. The polyalkylene glycol according to the present invention is, for example, polyethylene glycol, polypropylene glycol, polybutylene glycol or a polyalkylene glycol containing a proportion of the oxyethylene group and/or a proportion of the oxypropylene group and/or a proportion of the oxybutylene group. For example, the polyalkylene glycol according to the present invention may include a dominant proportion of the oxyethylene group in association with a secondary proportion of the oxypropylene group. Some specific examples of alkylene glycol polymers include: polyalkylene glycols having an average molecular weight of 1,000, 4,000, 6,000, 10,000 and 20,000 g/mol (in the case of the polyethylene glycols called PEG-1,000, PEG-4,000, PEG-6,000, PEG 10,000, PEG 20,000), the polyethylene polypropylene glycols having an ethylene oxide percentage between 20 and 80% by weight, and a propylene oxide percentage between 20 and 80% by weight.

Specifically, according to one aspect of the present invention, the copolymer includes:
a) 4% to 25% by weight of acrylic acid and/or methacrylic acid monomers and/or any of their salts,
b) 75% to 96% by weight of at least one monomer with the formula (I):

R—X—R′ (I)

according to which:

R represents a polymerisable unsaturated function, notably acrylate, methacrylate, methacrylurethane, vinyl or allyl,

R′ represents hydrogen or an alkyl group with from 1 to 4 carbon atoms,

X represents a structure with n unit(s) of ethylene oxide EO and m unit(s) of propylene oxide PO, arranged randomly,

m and n are 2 integers between 0 and 100, at least one of which is non-zero, and are such that m+n is greater than 17,

the said copolymer having a molecular mass between 200,000 and 50,000,000 g/mol.

Such copolymers are described in the technical sector of coating colors used in the manufacture of paper and board coated with the said dispersions. Notably, in patent application WO 2004/044022, such copolymers are described as agents for improving the activation of optical brightening in the manufacture of paper coating colors. As for patent EP 1 966 441, it describes these copolymers as water retention agents and rheology modifier agents for paper coating colors.

Surprisingly, such copolymers indeed exhibit a different rheological behaviour in paint formulations according to the present invention, in the presence of titanium dioxide particles.

Such copolymers are not described in the prior art as agents for improving the opacity of film that is dry or in the process of drying in a paint formulation including titanium dioxide particles.

Thus, the present invention is part of the sector of agents for improving optical activity, in particular the opacity of products that are dry or in the process of drying, resulting from aqueous formulations of titanium dioxide-based paints containing the said agents.

By “agent for improving the opacity of the film that is dry or in the process of drying” is meant an agent that, during or after drying, produces a product whose opacity is improved. The product is, in the case in point, a film of paint that is in the process of drying or a dry paint film, i.e., one resulting from the application of a specified thickness of a water-based paint formulation. In the context of the present invention, the term “improve” means to increase the value of the opacity for a paint formulation with a given quantity of TiO₂ and an agent according to the invention, compared to a measured opacity value for the same paint formulation which includes same quantity of TiO₂, but not the agent according to the invention.

By “opacity” is meant the ability of a film of paint of a determined application thickness to cover a black support and the same support in white in an equivalent manner. In other words, the opacity is the ability of the dry film or film that is in the process of drying to cover any color situated below. The opacity of a paint film is determined by measuring the reflectance R_{b} of a coat of paint of a given thickness on a black backing, and then the reflectance R_{w} of a coat of the same paint with the same thickness on a white backing. The opacity is the percentage of the R_{b}/R_{w} ratio. Reflectance is in this case the magnitude y of the xyz colour space. For a given application thickness, the person skilled in the art seeks to be as close as possible to an opacity of 100%.

While improving the brightness of the paint film is not an object of the present invention, the index of brightness is characterized in the examples of this present specification by measuring of the L* component in the Lab color space (L*a*b*), using a spectrophotometer. By “brightness” is meant the brightness index of the paint film as determined by measurement of the L* component in the Lab (L*a*b*) colour space using a spectrophotometer. L* varies between 0 (black) and 100 (white).

During the paint drying step, after its application to its support, the pigment and binder particles come closer together. The final evaporation of the aqueous phase requires these particles to come close together, to adsorb and/or merge to form a continuous film. During this final evaporation step, it is sought to prevent flocculation of the titanium dioxide particles as much as possible. Failing this, some of the optical qualities of these particles are lost. This patent application is related to this problem. More specifically, this application is based on a particular behaviour of the copolymer molecules of the present invention in paint formulations containing titanium dioxide particles. Without wishing to be bound by a theory of any kind with regard to the results obtained, the inventors are of the opinion that the copolymers according to the invention exhibit properties of steric hindrance that result in a spacing of the TiO₂ particles in paint formulations, but also maintain the separation of TiO₂ particles in the paint film during the drying step, thereby retaining the optical activity of each particle individually, starting from the paint application step and after drying of the film applied to its support.

The copolymers according to the invention are “spacing molecules” in paint formulations containing particles of titanium dioxide which significantly reduce the phenomenon of titanium dioxide particle flocculation during the paint drying step.

According to the invention, the copolymer used as an agent for improving the optical activity of titanium dioxide particles has a weight-average molecular mass between 200,000 and 50,000,000 g/mol.

It is interesting to note that, within the framework of the present invention, despite a high molecular weight, and in comparison to the polymers of the prior art, also of high molecular weight used as thickeners, the copolymers according to the invention do not induce a substantial change of viscosities in aqueous formulations that incorporate them at the indicated concentrations. This is an advantage for the formulator.

According to one aspect of the present invention, the copolymer used as a titanium dioxide particle optical activity-enhancing agent presents a weight-average molecular mass between 250,000 and 15,000,000 g/mol, for example between 300,000 g/mol and 6,000,000 g/mol as determined by Gel Permeation Chromatography (GPC).

According to one aspect of the present invention, the said water-soluble copolymer consists of:
a) 5 to 20% by weight of acrylic acid and/or methacrylic acid monomers and/or any of their salts, and
b) 80 to 95% by weight of at least one monomer with the formula (I) as described above.

According to another aspect of the present invention, the said water-soluble copolymer consists of:
A1) 4 to 15% by weight of acrylic acid monomers or any of its salts,
A2) 1 to 5% by weight of methacrylic acid monomers or any of its salts,
b) 80 to 95% by weight of at least one monomer with the formula (I).

According to still another aspect of the present invention, the said water-soluble copolymer is such as n and m are two non-zero integers and are such that n+m>50.

According to still another aspect of the present invention, the said water-soluble copolymer is such as n and m are two non-zero integers and are such that n+m>60.

According to one aspect of the present invention, the copolymer as defined above is used as a titanium dioxide particle optical activity-enhancing agent in a paint formulation with a pigment volume concentration (hereinafter PVC) between 15 and 70%.

The “pigment volume concentration” is defined by the following formula:

PVC(%)=100×V_{f}/(V_{f}+V_{b})

with V_{f} which represents the volume of mineral filler and (V_{b} which represents the volume of binder in the paint formulation.

According to another aspect of the present invention, the copolymer as defined above is used as a titanium dioxide particle optical activity-enhancing agent in a paint formulation with a pigment volume concentration (hereinafter PVC) between 15 and 50%.

The present invention also relates to paint formulations including titanium dioxide particles and a copolymer according to the invention.

Specifically, the present invention also relates a water-based paint formulation including:
water,
titanium dioxide particles, and
a water-soluble copolymer comprised of:
a) 4% to 25% by weight of acrylic acid and/or methacrylic acid monomers and/or any of their salts,
b) 75 to 96% by weight of at least one monomer with the formula (I):

R—X—R′ (I)
according to which:
R represents a polymerisable unsaturated function, notably acrylate, methacrylate, methacrylurethane, vinyl or allyl,
R′ represents hydrogen or an alkyl group with from 1 to 4 carbon atoms,
X represents a structure with n unit(s) of ethylene oxide EO and m unit(s) of propylene oxide PO, arranged randomly,
m and n are 2 integers between 0 and 100, at least one of which is non-zero, and are such that m+n is greater than 17,
   the said copolymer having a molecular mass between 250,000 and 50,000,000 g/mol.

According to one aspect of the present invention, the water-based paint formulation includes 0.05 to 5% by weight of the said copolymer.

According to another aspect of the present invention, the water-based paint formulation includes 0.1 to 2% by weight of the said copolymer.

According to one aspect of the present invention, the water-based paint formulation includes 4 to 40% by weight of titanium dioxide particles.

According to another aspect of the present invention, the water-based paint formulation includes 15 to 25% by weight of titanium dioxide particles.

According to still another aspect of the present invention, the water-based paint formulation includes at least one other pigment mineral filler selected from the group consisting of calcium carbonate, kaolin, and silicate.

According to yet another aspect, the pigmented mineral fillers of the water-based paint formulation of the present invention are:
from 30 to 90% by weight of titanium dioxide particles and
from 10 to 70% by weight of at least one other pigment mineral filler selected from the group consisting of calcium carbonate, kaolin and silicate.

The said copolymer according to the invention is obtained by known methods of conventional radical copolymerization in solution, in direct or inverse emulsion in bulk, in suspension or precipitation in suitable solvents, in the presence of known starters and transfer agents, or again, by processes of controlled radical polymerization such as the method known as Reversible Addition Fragmentation Transfer (RAFT), the method known as Atom Transfer Radical Polymerization (ATRP), the method known as Nitroxide Mediated Polymerization (NMP), or again, the method referred to as Cobaloxime Mediated Free Radical Polymerization.

The following examples will allow a better understanding of the present invention, without however limiting its scope.

### EXAMPLES

In each of the following examples, the molecular mass of the copolymers according to the invention is determined by Gel Permeation Chromatography (GPC) or equivalently, Steric Exclusion chromatography (SEC).

Such a technique makes use of a WATERS™ liquid chromatograph equipped with two detectors. One of these detectors combines the static dynamic scattering of light at an angle of 90° to the viscometry measured by a MALVERN™ VISCOTEK™ viscometer detector. The other of these detectors is a WATERS™ refractrometric concentration detector.

This liquid chromatography apparatus is equipped with steric exclusion columns properly chosen by the person skilled in the art in order to separate the different molecular weights of the polymers studied. The elution liquid phase is an aqueous phase containing 1% KNO₃.

In detail, as a first step the polymerization solution is diluted to 0.9% dry in the GPC eluent which is a 1% KNO₃ solution, and then it is filtered to 0.2 μm. 100 μL are then injected into the chromatography apparatus (eluent: a 1% KNO₃ solution).

The liquid chromatography apparatus contains an isocratic pump (WATERS™ 515), the flow rate of which is adjusted to 0.8 ml/min. The chromatography apparatus also includes an oven which itself includes the following system of columns in series: a 6 cm long, 40 mm inside diameter pre-column of the WATERS™ ULTRAHYDROGEL GUARD COLUMN type, a 30 cm long, 7.8 mm inside diameter linear column of the WATERS™ ULTRAHYDROGEL type, and two 30 cm long, 7.8 mm inside diameter 120 ANGSTROM WATERS™ ULTRAHYDROGEL type columns. As for the detection system, it consists on the one hand of a WATERS™ 410 type Refractive Index (RI) Detector, and on the other, of a dual viscometer and light scattering detector set an angle of 90°, of the MALVERN™ 270 DUAL DETECTOR type. The oven is brought to a temperature of 55° C., and the refractometer is brought to a temperature of 45° C.

The chromatography apparatus is calibrated with a single PEO 19k standard of the PolyCAL™ MALVERN™ type.

Preparation of the copolymers is done according to the processes known to the person skilled in the art. In particular, reference can be made to the different documents cited in the application as technological background.

In addition, the paints are formulated according to methods known to the person skilled in the art.

In the examples that follow, measurements of opacity and brightness are made as follows:

A 75 μm thick film is deposited on the surface of a black support, and on the same type of support with a white surface. 24 hours elapses after application of the film to the support at a temperature of approximately 25° C. before taking measurements of the reflectance R_{b} of the paint film on a black backing, and the reflectance R_{w} of the film on a white backing.

The opacity is the percentage of the R_{b}/R_{w} ratio. Also, the brightness index of the paint film is determined by measurement of the L* component in the Lab (L*a*b*) colour space using a spectrophotometer.

Also determined are the viscosities of the said formulations at different shear rates:
at a low shear rate, the Brookfield viscosity, which is measured using a Brookfield RVT type viscometer in a non-agitated flask at a temperature of 25° C. and two rotational speeds of 10 and 100 revolutions per minute with the appropriate spindle. The reading is taken after 1 minute of rotation. Two Brookfield viscosity measurements are thus obtained, designated μ_{BK10} and μ_{BK100} (mPa·s) respectively;
at an average shear rate: the Stormer viscosity, designated μₛ (Krebs Units) ;
at a high shear rate: the Cone Plan viscosity or ICI viscosity, designated μ₁ (Poises, 1P=100 mPa·s).

### Example 1

This example illustrates the use of an agent according to the invention in a water-based paint formulation (including a vinyl acrylic type binder), the composition of which is given in table 1 below.

TABLE 1

| Paint constituent | Mass (g) |
|---|---|
| Water | 314.0 |
| Thickener (Natrosol ® Plus 330) | 5.0 |
| Sodium carbonate | 2.0 |
| Ionic dispersant (KTTP) | 2.0 |
| Anti-foaming agent (FoamStar ® A-38) | 4.0 |
| Biocide (Proxel ® AQ) | 1.5 |
| Binder (UCAR ® Latex 310) | 395.0 |
| Silicate pigment (Minex ® 10) | See table 2 |
| TiO₂ pigment (Kronos ® 2310) | See table 2 |
| Total additives including the agent according | See table 2 |
| to the present invention | |

The tests that follow illustrate the use of a polymer according to the invention as an agent for increasing the opacity of the film that is dry or in the process of drying, of a paint formulation including titanium dioxide particles which enables a reduction in the amount of this pigment in paints.

In particular, the agent according to the invention here is a copolymer with an acrylic acid skeleton (8% by weight) and a methacrylic acid skeleton (2.8% by weight) and branched macromonomers with a structure of 48 EO units and 15 PO units (89.2% by weight), with a molecular weight of 336,500 g/mol.

All the results have been summarized in table 2.

For each test, the opacity, brightness and BK μ10, BK μ100, ICI and Stormer viscosities were determined according to the methods described above.

TABLE 2

| | | Test No. | | | | |
|---|---|---|---|---|---|---|
| | | 1 | 2 | 3 | 4 | 5 |
| TiO₂ pigment | Mass (g) | 300 | 270 | 270 | 270 | 270 |
| (Kronos ® | % | 100 | 90 | 90 | 90 | 90 |
| 2310) | | | | | | |

| | | | | | |
|---|---|---|---|---|---|
| Silicate pigment | 145 | 145 | 145 | 175 | 145 |
| (Minex ® 10) | | | | | |
| Dispersant (Tamol ® 731) | 8.20 | 8.20 | 1.50 | 1.50 | — |
| Dispersant | — | — | — | — | 1.50 |
| (Coadis ® 123K) | | | | | |
| Agent according to the | — | — | 6.90 | 6.90 | 6.90 |
| invention | | | | | |
| Total additives | 8.20 | 8.20 | 8.40 | 8.40 | 8.40 |
| Opacity | 96.59 | 95.77 | 96.53 | 96.62 | 96.24 |
| Brightness L* | 95.24 | 95.17 | 95.01 | 94.4 | 95.03 |
| μ_{S} | 84.1 | 80.8 | 79.4 | 77.6 | 79.9 |
| μ_{I} | 0.785 | 0.665 | 0.700 | 0.505 | 0.725 |
| μ_{BK10} | 4,640 | 4,180 | 3,620 | 3,380 | 3,740 |
| μ_{BK100} | 1,380 | 1,210 | 1,140 | 1,040 | 1,090 |

It should be noted that the total amount of additive (dispersant plus agent according to the invention) used is similar in all tests: 8.40 g for tests 3, 4 and 5 versus 8.20 g for tests 1 and 2.

The TiO₂ pigment here is in the form of a suspension of rutile titanium (approximately 76% dry extract by weight). The silicate pigment is in the powder form.

The agent according to the invention is in the form of a solution/emulsion in water at 25%.

The PVC is approximately 25%.

Test 1 corresponds to a control. In test 2, the amount of TiO₂ is reduced by 10% compared to test 1. A decrease of close to one point is then detected in the measured opacity. Thus, as expected, it is shown that a reduction of 10% in the amount of TiO₂ pigment leads to a significant reduction in the measured opacity.

In test 3, the amount of TiO₂ in the paint is reduced by 10%, but an agent according to the invention is added (proportion: 0.6% by weight). Thus, it is demonstrated that despite the decrease in the amount of TiO₂ in the paint, the opacity of the paint remains constant.

The agent according to the invention improves the spacing between the TiO₂ particles during the paint film drying step (measurement of the opacity of the dry paint film), which allows a better optical activity of the titanium dioxide particles in order to obtain a better opacity of the dry paint film, so that it is possible to decrease the proportion of the said TiO₂ particles in the paint while maintaining the same opacity level. It is also interesting to note that the viscosity measured in tests 3 and 5, specifically at a low or average shear gradient, are comparable to those of the control test.

In test 4, the amount of TiO₂ in the paint is reduced by 10%, an agent according to the invention is added (proportion 0.6% by weight, identical to test 2) and the loss of TiO₂ pigment is compensated for by the addition of 30 g of an another pigment, i.e., a silicate pigment. The measured opacity is then of the same order of magnitude as the opacity measured without compensation (test 3). Thus, the addition of an agent according to the invention allows a reduction in the amount of TiO₂ pigment particles without the need to compensate for this reduction by the addition of another pigment to the composition. This represents an advantage in terms of costs.

In test 5, a dispersant, namely Tamol® 731, is replaced by a dispersant with a different polymeric composition, i.e. Coadis® 123K. It is shown that the resulting opacity is of the same order of magnitude as that obtained for test 3 or test 4, so that the choice of the dispersant's polymeric composition does not, in this case of these tests, have an impact on the opacity value.

To be noted that the addition of an agent according to the invention has no significant effect on the brightness L* of the paint film.

### Example 2

This example illustrates the use of an agent according to the invention in another water-based paint formulation (including an acrylic type binder), the composition of which is given in table 3 below.

TABLE 3

| Paint constituent | Mass (g) |
|---|---|
| Water | 236.8 |
| Biocide (Proxel ® AQ) | 1.5 |
| Surfactant (Strodex ® PK-0VOC) | 2.0 |
| Anti-foaming agent (Rhodoline ® 643) | 6.0 |
| Neutralizing agent (AMP 95) | 2.0 |
| Binder (UCAR ® Latex 631) | 500.0 |
| Coalescent agent (Texanol ® | 12.5 |
| Thickener (Coapur ® XS 71) | 1.0 |
| Thickener (Rheotech ® 2000) | 7.0 |
| Kaolin Pigment (Polygloss ® 90) | 35.0 |
| TiO₂ pigment (Ti-Pure ® R-706) | See table 4 |
| Agent according to the invention | See table 4 |

In particular, the agent according to the invention here is a copolymer with an acrylic acid skeleton (8% by weight) and a methacrylic acid skeleton (2.8% by weight) and branched macromonomers with a structure (89.2% by weight), with a molecular weight of 336,500 g/mol.

All the results have been summarized in table 4.

For each test, the opacity, brightness and BK μ10, BK μ100, ICI and Stormer viscosities were determined according to the methods described above.

TABLE 4

| | | Test No. | | |
|---|---|---|---|---|
| | | 6 | 7 | 8 |
| TiO₂ pigment (Ti-Pure ® R-706) | Mass | 235 | 211.5 | 211.5 |
| | (g) | | | |
| | % | 100 | 90 | 90 |

| | | | |
|---|---|---|---|
| Dispersant (Rhodoline ® 286N) | 6.2 | 6.2 | 1.0 |
| Agent according to the invention | — | — | 27.0 |
| Opacity | 97.56 | 97.04 | 97.43 |
| Brightness L* | 96.06 | 95.79 | 95.60 |

The TiO₂ pigment here is in the form of a suspension of rutile titanium (approximately 76% dry extract by weight).

In test 2, the amount of TiO₂ in the paint is reduced by 10%. In doing so, the measured opacity is reduced. Thus, as expected, it is shown that a reduction of 10% in the amount of TiO₂ pigment leads to a reduction in the measured opacity.

In test 3, the amount of TiO₂ in the paint is reduced by 10%, but an agent according to the invention is added (proportion 3% by weight).

It is apparent that the measured opacity is similar to that obtained in the case of the control test at 100% TiO₂. The agent according to the invention therefore enables the maintenance of the spacing between the TiO₂ particles during the paint film drying step (measurement of the opacity of the dry paint film), which allows a better optical activity of the titanium dioxide particles. It is shown here that it is possible to decrease the amount of TiO₂ in paints without losing opacity on the paint film.

For all practical purposes, it is specified that the rheological properties of the various formulations presented are comparable between the different tests and compatible with the paint application.

To be noted that the addition of an agent according to the invention has no significant effect on the brightness L* of the paint film.

1. A method for improving the opacity of a paint film that is dry or in the process of drying, comprising combining, in a paint formulation, titanium dioxide and a water-soluble copolymer consisting of:
a) 4% to 25% by weight of acrylic acid and/or methacrylic acid monomers and/or any of their salts,
b) 75 to 96% by weight of at least one monomer with the formula (I):
R—X—R′ (I)
according to which:
R represents a polymerizable unsaturated function,
R′ represents hydrogen or an alkyl group with from 1 to 4 carbon atoms,
X represents a structure with n unit(s) of ethylene oxide EO and m unit(s) of propylene oxide PO, arranged randomly,
m and n are 2 integers between 0 and 100, at least one of which is non-zero, and are such that m+n is greater than 17,
said copolymer having a molecular mass between 200,000 and 50,000,000 g/mol.

2. The method according to claim 1, wherein said water-soluble copolymer has a molecular mass between 300,000 and 15,000,000 g/mol.

3. The method according to claim 1, wherein said copolymer is made up of:
a) 5% to 20% by weight of acrylic acid and/or methacrylic acid monomers and/or any of their salts, and
b) 80 to 95% by weight of at least one monomer with the formula (I).

4. The method according to claim 1, wherein said water-soluble copolymer is made up of:
A1) 4 to 15% by weight of acrylic acid monomers or any of its salts,
A2) 1 to 5% by weight of methacrylic acid monomers or any of its salts, and
b) 80 to 95% by weight of at least one monomer with the formula (I).

5. The method according to claim 1, wherein said water-soluble copolymer is such that n and m are two non-zero integers and are such that n+m>50.

6. A water-based paint formulation comprising:
water,
titanium dioxide particles, and
a water-soluble copolymer consisting essentially of:
a) 4% to 25% by weight of acrylic acid and/or methacrylic acid monomers and/or any of their salts,
b) 75 to 96% by weight of at least one monomer with the formula (I):
R—X—R′ (I)
according to which:
R represents a polymerizable unsaturated function,
R′ represents hydrogen or an alkyl group with from 1 to 4 carbon atoms,
X represents a structure with n unit(s) of ethylene oxide EO and m unit(s) of propylene oxide PO, arranged randomly,
m and n are 2 integers between 0 and 100, at least one of which is non-zero, and are such that m+n is greater than 17,
said copolymer having a molecular mass between 200,000 and 50,000,000 g/mol.

7. The water-based paint formulation according to claim 6, wherein said formulation comprises 0.05 to 5% by weight of said copolymer.

8. The water-based paint formulation according to claim 6, wherein said formulation comprises 4 to 40% by weight of titanium dioxide particles.

9. The water-based paint formulation according to claim 6, wherein said formulation comprises 15 to 25% by weight of titanium dioxide particles.

10. The water-based paint formulation according to claim 6, wherein said formulation further comprises at least one other pigment mineral filler selected from the group consisting of calcium carbonate, kaolin, and silicate.

11. The method according to claim 1, wherein R represents acrylate, methacrylate, methacrylurethane, vinyl or allyl.

12. The water-based paint formulation according to claim 6, wherein R represents acrylate, methacrylate, methacrylurethane, vinyl or allyl.
